(19) United States
(12) Patent Application Publication
(10) Pub. No.: US 2025/0096493 A1
(43) Pub. Date: Mar. 20, 2025

(54) BLADE AND FLUSH-MOUNT TERMINALS FOR AN ELECTRICAL FUSE

(71) Applicant: MERSEN USA EP Corp., Boonton, NJ (US)

(72) Inventor: Kevin M. Horne, Gloucester, MA (US)

(73) Assignee: MERSEN USA EP Corp., Boonton, NJ (US)

(21) Appl. No.: 18/536,375

(22) Filed: Dec. 12, 2023

Related U.S. Application Data
(60) Provisional application No. 63/539,133, filed on Sep. 19, 2023.

(51) Int. Cl. H01R 13/04; H01R 13/639; H01R 13/68; H01R 43/02

(52) U.S. Cl. CPC H01R 13/04; H01R 13/639; H01R 13/68; H01R 43/02

(57) ABSTRACT

A terminal for an electrical protection device includes a ferrule having a base and a wall disposed along a periphery of the base, wherein the base extends along a first plane and the wall extends along a direction that is substantially perpendicular to the first plane, whereby the base and the wall form a cup having an interior space. An electrical connector is attached to the ferrule, where the electrical connector extends out from the interior space.

### RELATED APPLICATION DATA

This application claims priority of U.S. Provisional Application No. 63/539,133 filed on Sep. 19, 2023, which is incorporated herein by reference in its entirety.

### FIELD OF THE INVENTION

The present invention relates generally to electrical protection devices, and more particularly to terminals for electrical protection devices.

### BACKGROUND OF THE INVENTION

Electrical protection devices, such as fuses, are widely used as overcurrent protection devices to prevent costly damage to electrical circuits. Terminals typically form an electrical connection between an electrical power source or power supply and an electrical component or a combination of components arranged in an electrical circuit. One or more fusible links or elements, or a fuse element assembly, is connected between the terminals, so that when electrical current flow through the fuse exceeds a predetermined limit, the fusible elements melt and opens one or more circuits through the fuse to prevent electrical component damage.

Existing terminals are either one piece formed by machining a solid block/bar of conductive material, or two individual pieces that are each formed from a solid block/bar of material and subsequently joined together. In forming the respective pieces of the conventional terminal, significant precision machining is required to form the various holes, slots and a diameter of the terminal. Further, such machining generates significant scrap material.

Many different types of fuse constructions exist, and large inventories of different types of terminals are typically required to meet a full range of circuit protection needs. It would be desirable to provide a lower cost terminal construction and to reduce terminal inventory issues.

### SUMMARY OF THE INVENTION

In accordance with the present invention, provided is an electric terminal that is simpler to manufacture and, during manufacture, produces less scrap material relative to conventional electric terminals. More particularly, an electric terminal in accordance with the invention is formed from multiple components, e.g., a ferrule and a connector blade, that are subsequently attached to each other. The ferrule has a cup portion that defines an interior space, and the connector blade is inserted into the interior space of the ferrule and secured thereto. At least some of the components of the terminal are hydro-formed, drawn, 3D printed and/or stamped.

According to one aspect of the invention, a terminal for an electrical protection device includes: a ferrule comprising a base and a wall disposed along a periphery of the base, wherein the base extends along a first plane and the wall extends along a direction that is substantially perpendicular to the first plane, whereby the base and the wall form a cup having an interior space, an electrical connector attached to the ferrule, wherein the electrical connector extends out from the interior space.

In one embodiment, the electrical connector is attached to the ferrule by at least one of a braze or weld.

In one embodiment, the wall includes a groove formed along a surface of the support wall.

In one embodiment, the base and the wall are one of circular or rectangular in shape.

In one embodiment, the base includes at least one of a slot, a recess or a through-hole.

In one embodiment, the electrical connector includes an elongated planar member with a through-hole disposed within the planar member.

In one embodiment, the electrical connector includes a protrusion arranged on an end of the electrical connector.

In one embodiment, the electrical connector includes a first elongated leg and a second elongated leg substantially parallel to the first elongated leg, and a bridge portion substantially perpendicular to the first and second elongated legs and connecting the first and second elongated legs to one another.

In one embodiment, the ferrule is formed using a metal drawing process.

According to another aspect of the invention, an electrical protection device includes: a body having an interior space; an electrical protection element disposed within the interior space; and the terminal as described herein, wherein the wall of the ferrule is disposed within the interior space of the body.

In one embodiment, the electrical protection device is an electric fuse.

In one embodiment, the body includes at least one through-hole disposed at an end of the body, and an adhesive is disposed within the recess and the through-hole, the adhesive securing the wall to the body.

According to yet another aspect of the invention, a method for producing a terminal for an electrical protection device includes: forming a ferrule having a base arranged in a first plane and a wall disposed along a periphery of the base and extending in a direction substantially perpendicular to the first plane, whereby the base and the wall form a cup having an interior space;

forming a connector having a proximal end and a distal end; inserting the proximal end of the connector into the interior space; and attaching the proximal end of the connector to the base.

In one embodiment, attaching includes at least one of brazing or welding the connector to the base.

In one embodiment, forming the ferrule includes forming the base to have one of a circular shape or a rectangular shape.

In one embodiment, forming the ferrule includes forming the wall to have a ring shape that spans about the periphery of the base.

In one embodiment, forming the connector includes forming the connector as an elongated planar member having a through-hole disposed within the planar member.

In one embodiment, forming the connector includes forming a protrusion on one end of connector.

In one embodiment, forming the ferrule further includes forming at least one of a slot, a recess or a through-hole in the base.

In one embodiment, forming the ferrule further includes forming at least one of a slot, a recess or a through-hole in the base, and wherein forming the connector includes forming a protrusion on one end of the connector, and wherein attaching the connector to the base includes placing the protrusion into one of the slot, recess or through-hole.

In one embodiment, forming the ferrule further includes forming at least one of a slot, a recess or a through-hole in the base, and wherein attaching the connector to the base includes placing the connector into one of the slot, recess or through-hole.

In one embodiment, forming the connector includes forming the connector with a first elongated leg and a second elongated leg substantially parallel to the first elongated leg, and a bridge portion substantially perpendicular to the first and second elongated legs and connecting the first and second elongated legs to one another.

In one embodiment, forming the connector includes forming the connector using at least one of a 3D printing process, a casting process, a machining process, a forging process, or a cutting process.

In one embodiment, forming the ferrule includes forming a groove along a surface of the wall.

In one embodiment, the method includes inserting the ferrule into an interior space of a fuse body, and securing the ferrule to the interior space of the fuse body to inhibit relative movement between the ferrule and the fuse body.

In one embodiment, securing includes injecting an adhesive in at least one through-hole formed in the fuse body, whereby the adhesive bonds to the wall and to the at least one through-hole to inhibit relative movement between the ferrule and the fuse body.

In one embodiment, the ferrule is formed using a metal drawing process.

An advantage of the device and method in accordance with the invention is the weight of the electric terminals is reduced. This is due at least in part to the components being thinly formed parts that require less material. Another advantage of the device and method in accordance with the invention is less machining operations are required to form the terminals, thereby saving both time and costs associated with such machining processes. Yet another advantage of the device and method in accordance with the present invention is it is adaptable to pre-existing fuses that use large mass blocks to mount elements and bodies to the cup-like ferrule, which needs no secondary machining. The terminal blade portion can be configured to meet different application demands while using the same ferrule of a given diameter. The device and method in accordance with the invention lends itself to have the products elements welded vs having to use high temperature leaded solders. Yet another advantage of the device and method in accordance with the invention is the insulative body is not compromised by the need to be mounted with conductive hardware or external conductive ferrule.

For example, conventional terminals may be formed from solid copper, brass or aluminum that is precisely machined down to a desired shape/size. Upon mounting the body to the terminals, blind holes are drilled through the body and into the terminals to provide a means for fastening the terminals to a body (e.g., pins may be inserted into the holes to secure the terminal to the body or the holes may be tapped and a threaded fastener screwed into the holes to secure the terminal to the body). In such case, for a specific size and type fused the block mass prior to machining may be 250-300 grams, while the resulting machined block may be 175-200 grams, i.e., 75-125 grams of scrap is produced in forming the conventional terminal. In contrast, a terminal formed in accordance with the invention for the same size and type fuse may be on the order of 75 grams, while producing little scrap material.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention may take physical form in certain parts and arrangement of parts, an embodiment of which is described in detail in the specification and illustrated in the accompanying drawings.

FIG. 1A is a perspective view of an exemplary terminal in accordance with an embodiment of the invention.

FIG. 1B is a front view of the terminal of FIG. 1A.

FIG. 1C is a rear view of the terminal of FIG. 1A.

FIG. 1D is a side view to the terminal of FIG. 1A.

FIG. 1E is a sectional view of the terminal of FIG. 1D taken along line A-A.

FIG. 2A is a perspective view of a connector used in the terminal of FIGS. 1A-1E.

FIGS. 2B, 2C and 2D are top, side, and front views, respectively, of the connector of FIG. 2A.

FIG. 3A is a perspective view of a ferrule used in the terminal of FIGS. 1A-1E.

FIG. 3B is a top view of the ferrule of FIG. 3A.

FIG. 3C is a sectional view of the ferrule of FIG. 3B taken along section line C-C.

FIG. 4A is a perspective partial cutaway view of a fuse utilizing the terminal of FIGS. 1A-1E.

FIGS. 4B, 4C and 4D are front, top, and side views, respectively, of the fuse of FIG. 4A.

FIG. 5A is a transparent view of the fuse of FIG. 4A illustrating a connector for securing the terminal to the fuse body.

FIG. 5B is a perspective view of the connector of FIG. 5A.

FIG. 6A is a perspective view of an exemplary terminal in accordance with another embodiment of the invention.

FIG. 6B is a front view of the terminal of FIG. 6A.

FIG. 6C is a sectional view of the terminal of FIG. 6B taken along section line A-A.

FIG. 6D is a sectional view of the terminal of FIG. 6B taken along section line B-B.

FIG. 7A is a perspective view of a connector used in the terminal of FIGS. 6A-6D.

FIGS. 7B and 7C are top and side views, respectively, of the connector of FIG. 7A.

FIG. 8A is a perspective view of a ferrule used in the terminal of FIGS. 6A-6D.

FIG. 8B is a front view of the connector of FIG. 8A.

FIG. 8C is a sectional view of the ferrule of FIG. 8B taken along line C-C.

FIG. 9A is a perspective view of a fuse utilizing the terminal of FIGS. 6A-6D.

FIGS. 9B, 9C and 9D are front, side and cutaway views, respectively, of the fuse of FIG. 9A.

### DETAILED DESCRIPTION OF THE INVENTION

Embodiments of the present invention will now be described with reference to the drawings, wherein like reference numerals are used to refer to like elements throughout. It will be understood that the figures are not necessarily to scale.

In accordance with the present invention, electrical terminals for electrical protection devices and a method for making such electrical terminals are disclosed. The electrical terminal in accordance with the invention is constructed from two conductive parts, such as copper, brass, aluminum, or other conductive metal to form a homogeneous terminal. In one embodiment the two conductive parts are formed from the same conductive material, while in another embodiment the two conductive parts are formed from different conductive material. To form the terminal, the two parts are secured to one another, for example, by welding, brazing, or other conventional means for securing two conductors to each other. The assembly of the two conductive parts can be tin, silver, nickel, or copper plated as needed.

The electric terminals may be configured for various applications. For example, in low voltage applications the terminals may be formed with a cup portion and a blade portion attached to the cup portion, while in medium and high-voltage applications the terminals may be formed with a cup portion and a riser portion attached to the cup portion. The blade portion and riser portion provide the physical means by which the assembled terminal is connected to busbar or fuse holder that in turn is connected/connectable to a circuit.

As discussed in further detail below, regardless of the application of the electrical protection device, the cup portion of the terminal may be formed using a metal drawing process, a hydro-forming process, or a 3D printing process, which requires no secondary machining. The blade portion of the terminal and riser portion of the terminal may be formed by a stamping, machining, laser cutting, casting, forging or 3D printing manufacturing method.

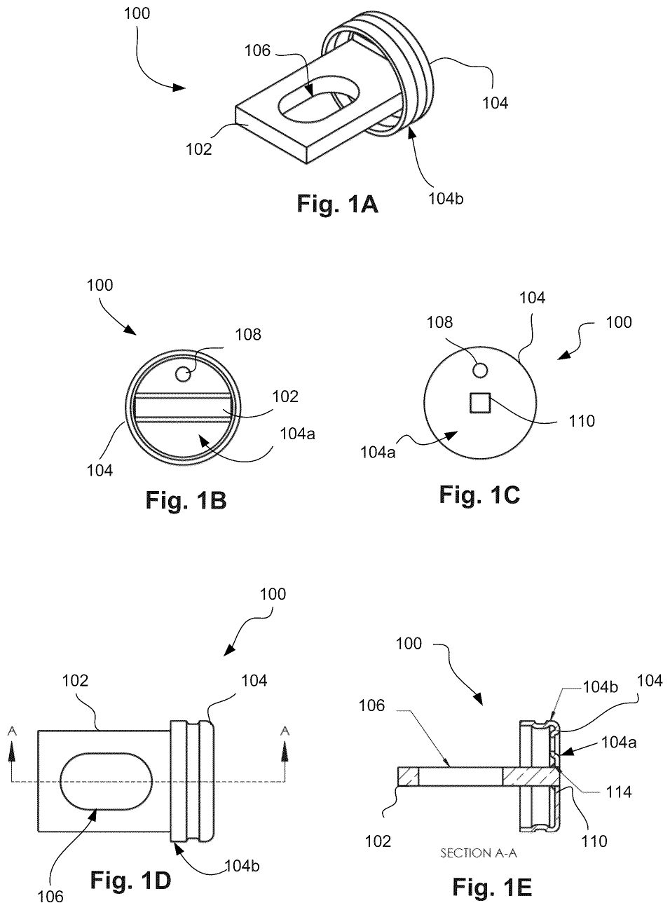

Referring to FIGS. 1A-1E, illustrated is an electric terminal 100 in accordance with an embodiment of the invention. The terminal 100 is formed from two components, namely, a connector 102 and a ferrule 104, where the connector 102 and ferrule 104 are formed independently from one another. In the exemplary embodiment the connector 102 is in the form of an elongated member (e.g., a fuse blade) having a through-hole 106 formed therein. The through-hole 106 provides a means for securing the connector 102 (and thus the terminal 100) to an electrical connector, such as a bus bar or fuse holder (not shown). The ferrule 104 is formed as a cup having a base 104a, e.g., a planar support portion, that lies in a first plane and a tubular wall 104b integrally formed with the base 104a, the tubular wall 104b forming a rim along a periphery of the base 104a. The tubular wall 104b extends in a direction substantially perpendicular to the first plane. As used herein, the term “substantially perpendicular” is defined as 90 degrees, plus or minus 10 degrees, while the term “substantially parallel” is defined as 0 degrees, plus or minus 10 degrees. While a circularly-shaped ferrule 104 is shown, other shapes are possible. For example, the ferrule 104 may have a square or rectangular shape, or any other shape that suits a specific application of the electrical protection device to which the terminal 100 may be applied.

The base 104a includes a first through-hole 108, which as described in further detail below, can be used to fill an electrical protection device with a spark-inhibiting material. The base 104a may also include a second through-hole 110, which as described in further detail below accepts a corresponding boss or protrusion formed in the connector 102. The boss/protrusion enables the connector 102 to be inserted in a specific position within the ferrule 104 and the mating of the boss/protrusion with the through hole 110 enhances strength of the overall terminal 100. Alternatively, a slot or recess may be formed in the base 104a, the slot or recess corresponding to a shape of the connector 102. The slot or recess may be configured to accept the connector 102 and maintain its orientation relative to the ferrule 104. As best seen in FIG. 1E, a braze or weld 114 secures the connector 102 to the ferrule 104.

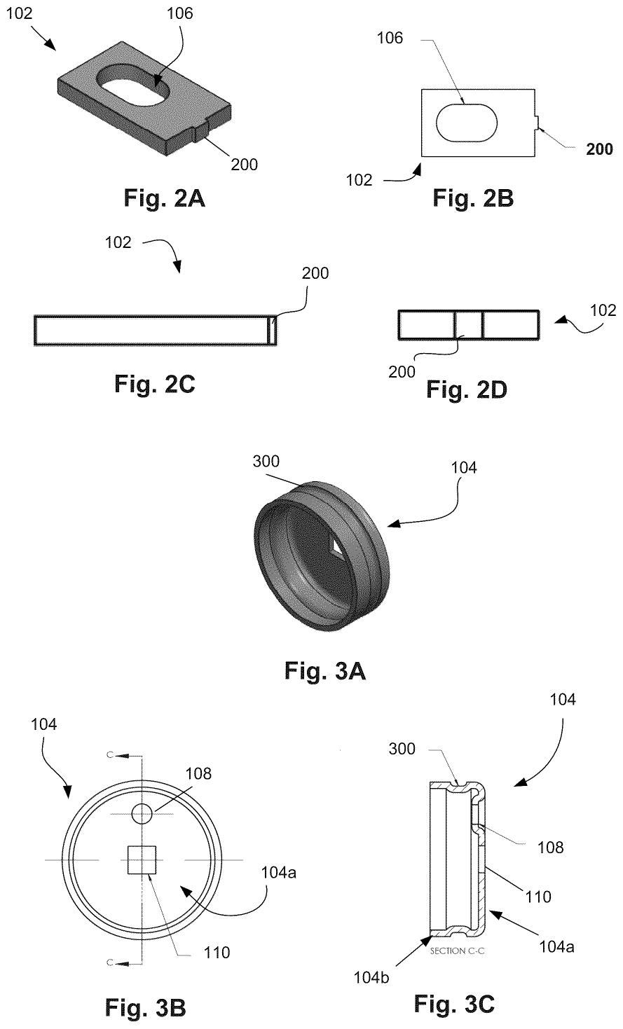

Moving to FIGS. 2A-2D, illustrated are a perspective, top, side and end view of the exemplary connector 102 of FIGS. 1A-1E. As can be seen, the exemplary connector 102 is an elongated member having a rectangular shape, with a through-hole 106 formed therein. In the illustrated embodiment, the through-hole 106 is semi rectangular, with the length and width of the through-hole 106 being different to enable some lateral movement of the connector 102 when securing the terminal 100 to a circuit. The connector 102 further includes a boss or protrusion 200, which as discussed previously cooperates with a through-hole 110 formed in the base 104a. Alternatively, the connector 102 may cooperate with a slot formed in the base 104a, the slot dimensions corresponding to the connector dimensions. The connector 102 may be formed, for example, using a 3D printing process, a casting process, a machining process, a forging process, or a cutting process.

Referring to FIGS. 3A-3C, illustrated are perspective, front and cross-section view of the exemplary ferrule 104 of FIGS. 1A-1E. In accordance with the invention, the ferrule 104 is formed using a drawing process. Drawing is a sheet metal forming process in which a sheet metal blank is radially drawn into a forming die by the mechanical action of a punch. Drawing is a shape transformation process with material retention. The process is considered “deep” drawing when the depth of the drawn part exceeds its diameter. This is achieved by redrawing the part through a series of dies.

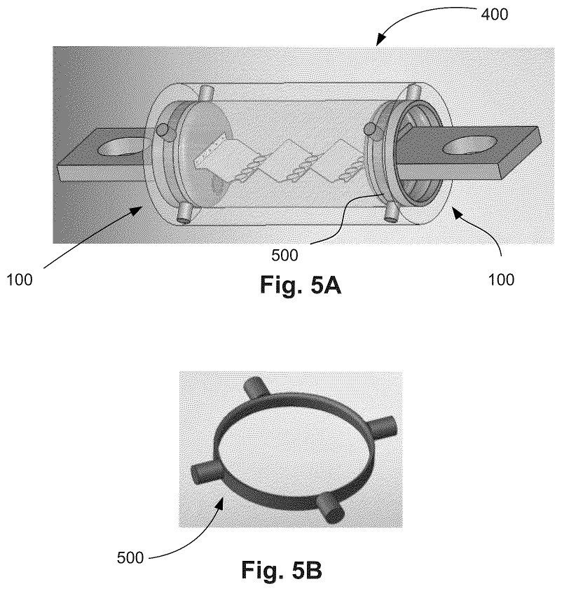

As previously discussed, the ferrule 104 has a cup shape with a base 104a having a tubular wall 104b formed along a periphery of the base 104a, and first and second through-holes 108, 110 formed in the base 104a. The through-hole 108 enables a body of an electrical protection device (i.e., a device to which the terminal is attached to form an electrical connection means) to be filled with an arc-inhibiting material, while the through-hole 110 accepts a boss from the connector 102. Formed along an outer circumferential surface of the wall 104b is a groove 300. As discussed in more detail below with respect to FIGS. 5A-5B, the groove 300 accepts an adhesive material that secures the terminal 100 to a body of an electrical protection device to which the terminal is affixed.

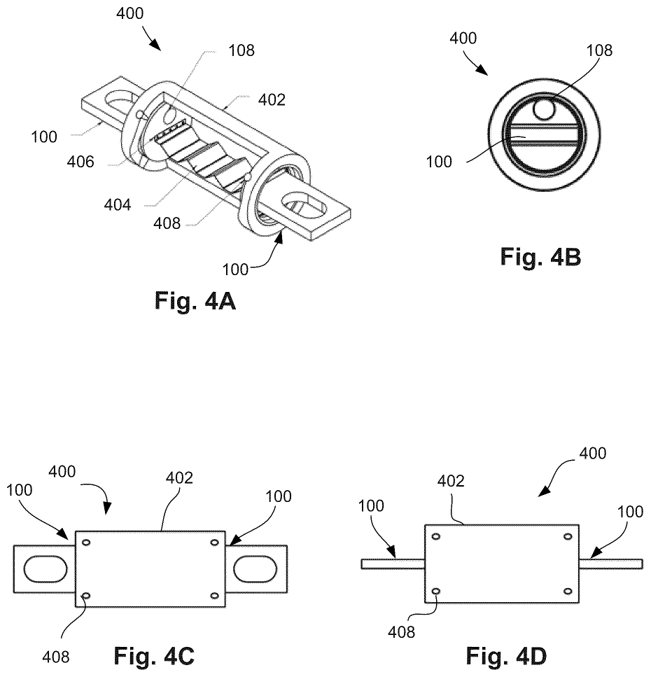

‘Moving to FIGS. 4A-4D, illustrated are a perspective, front, top and side views of an exemplary electrical protection device 400 in the form an electric fuse, the fuse 400 including terminals 100 in accordance with an embodiment of the present invention. More specifically, the fuse 400 includes an insulating body 402 in the form of a tube having open ends. Arranged within the body 402 is a fuse element 404, the fuse element 404 being secured to opposing terminals 100 via a solder or weld connection 406. As best seen in FIGS. 4C and 4D, the fuse body 402 includes injection ports 408 for receiving an adhesive material, such as an epoxy material, that secures the terminals 100 to the fuse body 402.

Upon the fuse 400 being assembled, an adhesive, such as an epoxy material (e.g., an epoxy resin), is injected into the injection ports 408 and the adhesive travels around the groove 300 of the wall 104b. As the adhesive cures within the grove 300 and the injection ports 408, it locks the ferrule 104 in the fuse body 402. Silica sand or other arc-suppression material may be injected into the fuse body 400 via the first through-hole 108, and the through-hole 108 is subsequently plugged to prevent leakage of the arc-suppression material. FIG. 5A illustrates the fuse 400 injected with an adhesive to form a locking ring 500, and FIG. 5B illustrates the resulting locking ring 500. As can be seen in FIG. 5B, the adhesive conforms to a shape of the ports 408 and the groove 300 to lock the ferrule 104 and thus the terminal 100 in the fuse body 402.

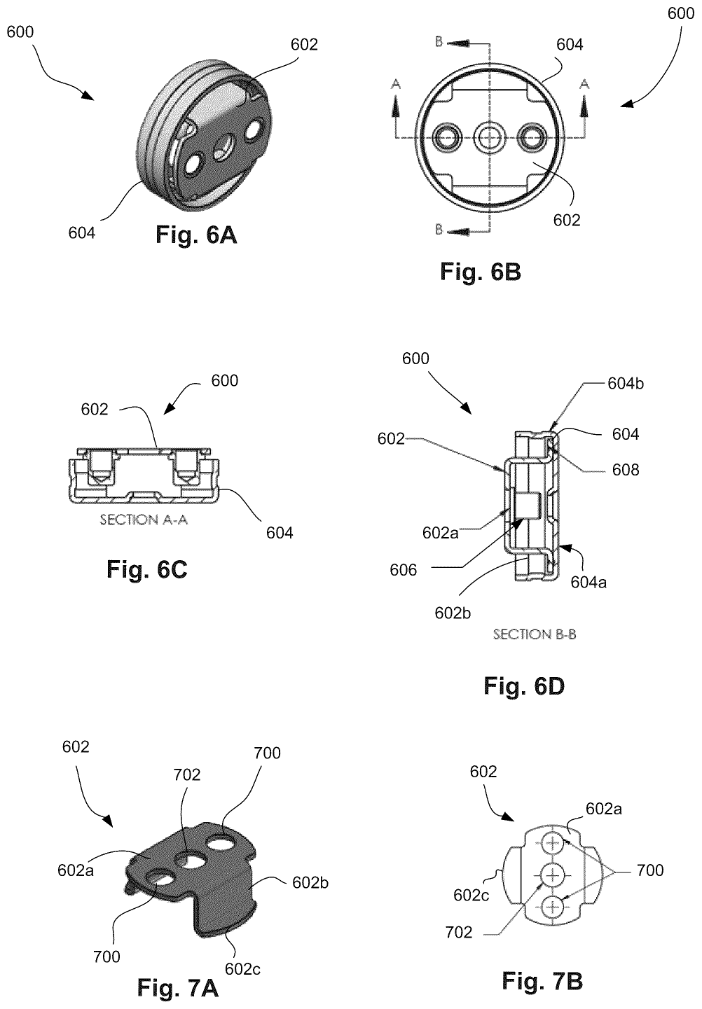

Moving now to FIGS. 6A-6D, illustrated are perspective, front and sectional views of a terminal 600 in accordance with another embodiment of the invention. The terminal 600 is formed from two components, namely, a connector 602 and a ferrule 604, where the connector 602 and ferrule 604 are formed independently from one another. In the exemplary embodiment the connector 602 is in the form of a riser and the ferrule 604 is in the form of a cup. While a circularly-shaped ferrule 604 is shown, other shapes are possible. For example, the ferrule 604 may have a square or rectangular shape, or any other shape that suits a specific application of the protection device to which the terminal 600 is applied. A braze or weld 608 (best seen in FIG. 6D) secures the connector 602 to the ferrule 604.

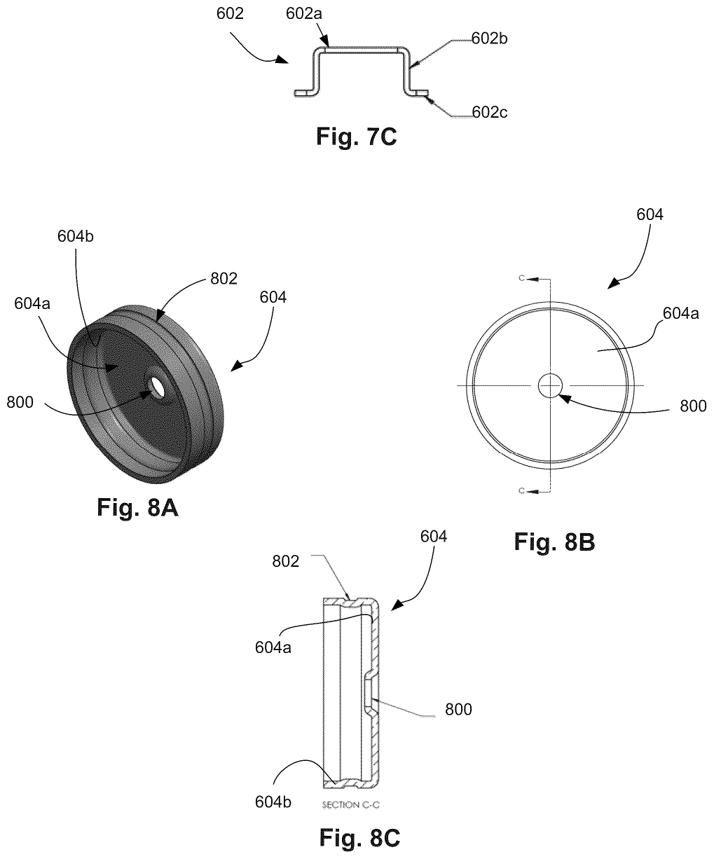

With additional reference to FIGS. 7A-7C, illustrated are a perspective, top and side view of the exemplary connector 602 of FIGS. 6A-6D. As discussed with respect to FIGS. 6A-6D, the exemplary connector 602 is in the form of a riser and has a semi-circular shape with a base 602 (e.g., a planar support) that lies in a first plane, two legs 602b extending from a surface of the base 602a in a direction substantially perpendicular to the first plane, and feet 602c extending from the legs 602b in a direction substantially parallel to the first plane. Preferably, the legs 602b and feet 602c are integrally formed with the base 602a, although they also may be separately formed and subsequently attached to the base 602a.

The connector 602 further includes first through-holes 700 formed on respective ends of the base 602a. The first through-holes 700 may receive a captive fastener 606 (FIG. 6D) having a threaded bore adapted to receive a screw fastener for securing the connector 602 (and thus the terminal 600) to an electrical conductor, such as a fuse mount and/or an electric conductor (not shown). The connector 602 further includes a second through-hole 702 arranged between the first through-holes 700. As discussed in further detail below, the second through-hole 702 corresponds to a through-hole in the ferrule 604. The connector 602 may be formed, for example, using a 3D printing process, a casting process, a machining process, a forging process, or a cutting process.

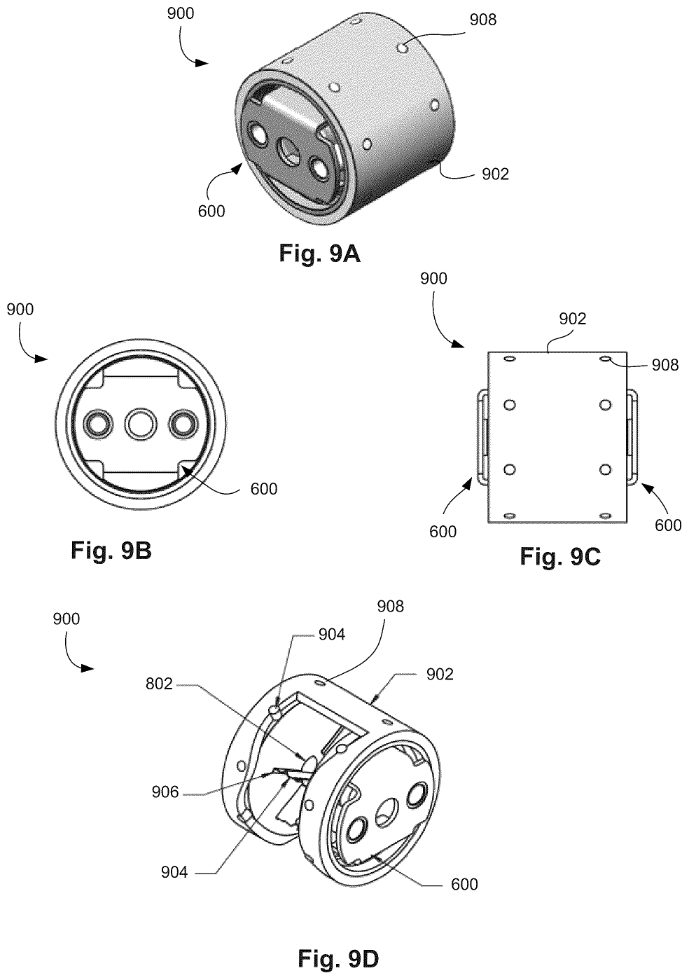

Referring to FIGS. 8A-8C, illustrated are perspective, front and cross-section views of the exemplary ferrule 604 of FIGS. 6A-6D. In accordance with the invention, the ferrule 604 is formed using a drawing process (e.g., either a drawn or deep drawn process). The ferrule 604 is formed as a cup having a base 604a that lies in a first plane and a tubular wall 604b integrally formed with the support portion 604a, the tubular wall forming a wall along a periphery of the ferrule 604 that extends in a direction substantially perpendicular to the first plane. The base 604a includes a first through-hole 800, which as described in further detail below, can be used to fill an electrical protection device with an arc-inhibiting material. Formed along an outer circumferential surface of the wall 604b is a groove 802. As discussed in more detail below with respect to FIGS. 9A-9D, the groove 802 accepts an adhesive that secures the terminal 600 to a body of an electrical protection device to which the terminal 600 is affixed.

‘Moving to FIGS. 9A-9D, illustrated are a perspective, front, side and cutaway views of an exemplary electrical protection device 900 in the form an electrical fuse, the fuse 900 including terminals 600 in accordance with an embodiment of the present invention. More specifically, the fuse 900 includes an insulating body 902 in the form of a tube having open ends. Arranged within the body 902 is a fuse element 904, the fuse element 904 being secured to opposing terminals 600 via a braze or weld connection 906. As best seen in FIGS. 9A, 9C and 9D, the fuse body 902 includes injection ports 908 for receiving an adhesive material, such as an epoxy resin, that secures the terminals 600 to the fuse body 902. Upon the fuse 900 being assembled, an adhesive is injected into the injection ports 908, and the adhesive travels around the groove 802 of the wall 604b. As the adhesive cures within the grove 802 and the injection ports 908, it locks the ferrule 604 in the fuse body 902. Silica sand or other arc-suppression material then may be injected into the fuse body 902 via the through-holes 702 and 800, and the through-holes are subsequently plugged to prevent leakage of the arc-suppression material.

Modifications and alterations of the structures shown in the drawings will become apparent to those skilled in the art after reading the present specification. It is intended that all such modifications and all variations being included in so far as they come within the scope of the patent as claimed or the equivalence thereof.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A terminal for an electrical protection device, comprising:
a ferrule comprising a base and a wall disposed along a periphery of the base, wherein the base extends along a first plane and the wall extends along a direction that is substantially perpendicular to the first plane, whereby the base and the wall form a cup having an interior space,
an electrical connector attached to the ferrule, wherein the electrical connector extends out from the interior space.

2. The terminal according to claim 1, wherein the electrical connector is attached to the ferrule by at least one of a braze or weld.

3. The terminal according to claim 1, wherein the wall comprises a groove formed along a surface of the support wall.

4. The terminal according to claim 1, wherein the base and the wall are one of circular or rectangular in shape.

5. The terminal according to claim 1, wherein the base comprises at least one of a slot, a recess or a through-hole.

6. The terminal according to claim 1, wherein the electrical connector comprises an elongated planar member with a through-hole disposed within the planar member.

7. The terminal according to claim 1, wherein the electrical connector comprises a protrusion arranged on an end of the electrical connector.

8. The terminal according to claim 1, wherein the electrical connector comprises a first elongated leg and a second elongated leg substantially parallel to the first elongated leg, and a bridge portion substantially perpendicular to the first and second elongated legs and connecting the first and second elongated legs to one another.

9. The terminal according to claim 1, wherein the ferrule is formed using a metal drawing process.

10. An electrical protection device, comprising:
a body having an interior space;
an electrical protection element disposed within the interior space; and
the terminal according to claim 1, wherein the wall of the ferrule is disposed within the interior space of the body.

11. The electrical protection device according to claim 10, wherein the electrical protection device comprises an electric fuse.

12. The electrical protection device according to claim 10, wherein the body comprises at least one through-hole disposed at an end of the body, further comprising an adhesive disposed within the recess and the through-hole, the adhesive securing the wall to the body.

13. A method for producing a terminal for an electrical protection device, comprising:
forming a ferrule having a base arranged in a first plane and a wall disposed along a periphery of the base and extending in a direction substantially perpendicular to the first plane, whereby the base and the wall form a cup having an interior space;
forming a connector having a proximal end and a distal end;
inserting the proximal end of the connector into the interior space; and
attaching the proximal end of the connector to the base.

14. The method according to claim 13, wherein attaching comprises at least one of brazing or welding the connector to the base.

15. The method according to claim 13, wherein forming the ferrule comprises forming the base to have one of a circular shape or a rectangular shape.

16. The method according to claim 13, wherein forming the ferrule comprises forming the wall to have a ring shape that spans about the periphery of the base.

17. The method according to claim 13, wherein forming the connector comprises forming the connector as an elongated planar member having a through-hole disposed within the planar member.

18. The method according to claim 13, wherein forming the connector comprises forming a protrusion on one end of connector.

19. The method according to claim 13, wherein forming the ferrule further comprises forming at least one of a slot, a recess or a through-hole in the base.

20. The method according to claim 13, wherein forming the ferrule further comprises forming at least one of a slot, a recess or a through-hole in the base, and wherein forming the connector comprises forming a protrusion on one end of the connector, and wherein attaching the connector to the base comprises placing the protrusion into one of the slot, recess or through-hole.

21. The method according to claim 13, wherein forming the ferrule further comprises forming at least one of a slot, a recess or a through-hole in the base, and wherein attaching the connector to the base comprises placing the connector into one of the slot, recess or through-hole.

22. The method according to claim 13, wherein forming the connector comprises forming the connector with a first elongated leg and a second elongated leg substantially parallel to the first elongated leg, and a bridge portion substantially perpendicular to the first and second elongated legs and connecting the first and second elongated legs to one another.

23. The method according to claim 13, wherein forming the connector comprises forming the connector using at least one of a 3D printing process, a casting process, a machining process, a forging process, or a cutting process.

24. The method according to claim 13, wherein forming the ferrule comprises forming a groove along a surface of the wall.

25. The method according to claim 13, further comprising inserting the ferrule into an interior space of a fuse body, and securing the ferrule to the interior space of the fuse body to inhibit relative movement between the ferrule and the fuse body.

26. The method according to claim 25, wherein securing comprises injecting an adhesive in at least one through-hole formed in the fuse body, whereby the adhesive bonds to the wall and to the at least one through-hole to inhibit relative movement between the ferrule and the fusc body.

27. The method according to claim 13. wherein the ferrule is formed using a metal drawing process.
